(19) United States
(12) Patent Application Publication
(10) Pub. No.: US 2016/0323077 A1
(43) Pub. Date: Nov. 3, 2016

(54) Method and apparatus for allocating resource to LTE cell, and base station and storage medium

(71) Applicant: ZTE CORPORATION, Shenzhen, Guangdong (CN)

(72) Inventor: Xiaoxue Yin, Shenzhen (CN)

(21) Appl. No.: 15/108,496

(22) PCT Filed: Jun. 10, 2014
(86) PCT No.: PCT/CN2014/079637

§ 371 Date: Jun. 27, 2016

(30) Foreign Application Priority Data
Dec. 30, 2013 (CN) 201310745645.3

(51) Int. Cl. H04L 5/00; H04W 72/08; H04W 72/04

(52) U.S. Cl. CPC H04L 5/0032; H04L 5/001; H04W 72/0493; H04W 72/082

(57) ABSTRACT

A method and apparatus for resource allocation to a LTE cell, a base station and a storage medium are provided. A resource allocation random factor M is generated for the LTE cell based on a cell ID of an LTE cell a resource allocation random number K is generated using the resource allocation random factor M, the generated resource allocation random number K being greater than or equal to 0 and being less than or equal to N1−N2, N1 being a total number N1 of PRBs corresponding to a system bandwidth of an LTE system, and N2 being a total number of PRBs needing to be scheduled to the LTE cell currently; a start position for allocating PRBs to the LTE cell is determined according to the resource allocation random number K; and PRBs are allocated to the LTE cell from the start position.

### TECHNICAL FIELD

The present disclosure relates to the field of communications, and in particular to a method and apparatus for allocating a resource to a Long Term Evolution (LTE) cell, a base station and a storage medium.

### BACKGROUND

With the development of a wireless broadband communication technology, how to solve the interference problem in a wireless system has become a current hotspot. An LTE system, as a mainstream technology for wireless communication, adopts same-frequency networking, and the interference problem is one of the inevitable problems. In a conventional LTE wireless communication system, a wireless resource allocation manner takes a Physical Resource Block (PRB) as a unit, and each cell has the same PRB allocation manner in which a PRB is allocated to a high frequency band by taking a lowest frequency as a start position of the PRB, thereby causing overlapping of inter-cell low-frequency PRBs. As shown in FIG. 1, RB0, RB1, RB2 and the like are overlapped among PRBs allocated to an LTE cell 1 and an LTE cell 2. Due to the overlapping, pieces of marginal User Equipment (UE) between several adjacent cells will strongly interfere with one another, thereby influencing the performance of an entire network.

### SUMMARY

In view of this, the embodiments of the present disclosure provide a method and apparatus for resource allocation to an LTE cell, a base station and a storage medium, which can be used to solve the problem that resource blocks are overlapped when a conventional resource allocation method is adopted in a process of allocating PRBs to each cell in an LTE system.

According to a first aspect, an embodiment of the present disclosure provides a method for resource allocation to an LTE cell, which may include that:

a resource allocation random factor M is generated for the LTE cell based on a cell identification number (cell ID) of the LTE cell;

a resource allocation random number K is generated using the resource allocation random factor M, the resource allocation random number K being greater than or equal to 0 and being less than or equal to N1−N2, the N1 being a total number of PRBs corresponding to a system bandwidth of an LTE system, and the N2 being a total number of PRBs needing to be scheduled to the LTE cell currently;

a start position for allocating PRBs to the LTE cell is determined according to the resource allocation random number K; and PRBs are allocated to the LTE cell from the start position.

Preferably, the step that the resource allocation random factor M is generated for the LTE cell based on the cell ID of the LTE cell may include that:

the cell ID of the LTE cell is directly taken as the resource allocation random factor M of the LTE cell; or

a sum of the cell ID of the LTE cell and a system frame number of the LTE system at a current Transmission Time Interval (TTI) are taken as the resource allocation random factor M of the LTE cell; or

a sum of the cell ID of the LTE cell and a system subframe number of the LTE system at the current TTI are taken as the resource allocation random factor M of the LTE cell; or

a sum of the cell ID of the LTE cell and the system frame number and system subframe number of the LTE system at the current TTI are taken as the resource allocation random factor M of the LTE cell.

Preferably, the step that the resource allocation random number K is generated using the resource allocation random factor M may include that:

a pseudorandom sequence is generated by taking the resource allocation random factor M as a seed; and

a number is selected from the pseudorandom sequence and taken as the resource allocation random number K.

Preferably, when PRBs are allocated to an uplink physical channel of the LTE cell, the resource allocation random number K may be a start position for allocating the PRBs to the uplink physical channel of the LTE cell, wherein the total number N1 of PRBs may be a total number of PRBs corresponding to an uplink system bandwidth of the LTE system, and the total number N2 of PRBs may be a total number of uplink PRBs needing to be scheduled to the LTE cell currently;

correspondingly, a number may be selected from the pseudorandom sequence as the resource allocation random number K, K=Rand[M,(0,N1−N2)];

where Rand[ ] may be a random-number generation function; and the Rand[M,(0,N1−N2)] may be generating a random number between 0 and N1−N2, and the resource allocation random factor M may be taken as a seed for generating a random sequence from which the random number is generated.

Preferably, when PRBs are allocated to a downlink physical channel of the LTE cell, a position of a downlink resource unit corresponding to a position of a PRB where the resource allocation random number K is located may be taken as a start position for allocating downlink PRBs to the LTE cell, wherein the total number N1 of PRBs may be a total number of PRBs corresponding to a downlink system bandwidth of the LTE system, and the total number N2 of PRBs may be a total number of downlink PRBs needing to be scheduled to the LTE cell currently;

correspondingly, a number may be selected from the pseudorandom sequence as the resource allocation random number K, K=H*floor[Rand(M,(0,N1−N2))/H];

where the floor[ ] may represent rounding down; the Rand( ) may be a random-number generation function; the Rand(M,(0,N1−N2)) may be generating a random number between 0 and N1−N2, and the resource allocation random factor M may be taken as a seed for generating a random sequence from which the random number is generated; and the H may be a size of the downlink resource unit corresponding to the downlink system bandwidth of the LTE system.

Preferably, when the PRBs are allocated to the downlink physical channel of the LTE cell according to a PRB continuous allocation rule, the step that the PRBs are allocated to the LTE cell from the start position may further include that:

when it is determined that N1−K−J<N2, J being a total number of occupied PRBs, an available PRB segment is searched for in a direction from low frequency to high frequency starting from a position of a lowest-frequency PRB, and a start position of the downlink resource unit corresponding to a start position of the PRB segment is taken as a new start position for allocating the PRBs to the downlink physical channel of the cell.

According to a second aspect, an embodiment of the present disclosure provides an apparatus for resource allocation to an LTE cell, which may include: a random factor generation module, a random number acquisition module, a position determination module and a resource allocation module, wherein the random factor generation module may be configured to generate, based on a cell ID of the LTE cell, a resource allocation random factor M for the LTE cell;

the random number acquisition module may be configured to generate a resource allocation random number K using the resource allocation random factor M, the resource allocation random number K being greater than or equal to 0 and being less than or equal to N1−N2, where the N1 being a total number of PRBs corresponding to a system bandwidth of an LTE system, and the N2 being a total number of PRBs needing to be scheduled to the LTE cell currently;

the position determination module may be configured to determine a start position for allocating PRBs to the LTE cell according to the resource allocation random number K; and

the resource allocation module may be configured to allocate PRBs to the LTE cell from the start position.

Preferably, the random factor generation module may be configured to directly take the cell ID of the LTE cell as the resource allocation random factor M of the LTE cell; or

the random factor generation module may be configured to take a sum of the cell ID of the LTE cell and a system frame number of the LTE system at a current TTI as the resource allocation random factor M of the LTE cell; or

the random factor generation module may be configured to take a sum of the cell ID of the LTE cell and a system subframe number of the LTE system at the current TTI as the resource allocation random factor M of the LTE cell; or

the random factor generation module may be configured to take a sum of the cell ID of the LTE cell and the system frame number and system subframe number of the LTE system at the current TTI as the resource allocation random factor M of the LTE cell.

Preferably, the random number acquisition module may include an initialization sub-module and a random number generation sub-module, wherein

the initialization sub-module may be configured to initialize a pre-set random sequence using the resource allocation random factor M, namely generate a pseudorandom sequence by taking the resource allocation random factor M as a seed; and

the random number generation sub-module may be configured to select a number from the pseudorandom sequence as the resource allocation random number K.

Preferably, when PRBs are allocated to an uplink physical channel of the LTE cell, the position determination module may be configured to determine the resource allocation random number K as a start position for allocating the PRBs to the uplink physical channel of the LTE cell, wherein the total number N1 of PRBs may be a total number of PRBs corresponding to an uplink system bandwidth of the LTE system, and the total number N2 of PRBs may be a total number of uplink PRBs needing to be scheduled to the LTE cell currently;

correspondingly, the random number generation sub-module may be configured to select a number from the pseudorandom sequence as the resource allocation random number K, K=Rand[M,(0,N1−N2)];

where the Rand[ ] may be a random-number generation function; and Rand[M,(0,N1−N2)] may be generating a random number between 0 and N1−N2, and the resource allocation random factor M may be taken as a seed for generating a random sequence where the random number is generated.

Preferably, when PRBs are allocated to a downlink physical channel of the LTE cell, the position determination module may be configured to determine a position of a downlink resource unit corresponding to a position of a PRB where the resource allocation random number K is located as a start position for allocating downlink PRBs to the LTE cell, wherein the total number N1 of PRBs may be a total number of PRBs corresponding to a downlink system bandwidth of the LTE system, and the total number N2 of PRBs may be a total number of downlink PRBs needing to be scheduled to the LTE cell currently;

correspondingly, the random number generation sub-module may be configured to select a number from the pseudorandom sequence as the resource allocation random number K, K=H*floor[Rand(M,(0,N1−N2))/H];

floor[ ] may represent rounding down; Rand( ) may be a random-number generation function; Rand(M,(0,N1−N2)) may be generating a random number between 0 and N1−N2, and the resource allocation random factor M may be taken as a seed for generating a random sequence from which the random number is generated; and H may be a size of the downlink resource unit corresponding to the downlink system bandwidth of the LTE system.

Preferably, the resource allocation apparatus may further include a judgement module, wherein

when the resource allocation module allocates the PRBs to the downlink physical channel of the LTE cell according to a PRB continuous allocation rule, the judgement module may be configured to judge that N1−K−J<N2 in a process that the resource allocation module allocates the PRBs to the LTE cell from the start position, the J may be a total number of occupied PRBs, and search for an available PRB segment in a direction from low frequency to high frequency starting from a position of a lowest-frequency PRB; and

correspondingly, the position determination module may be further configured to take a start position of the downlink resource unit corresponding to a start position of the PRB segment as a new start position for allocating the PRBs to the downlink physical channel of the cell.

According to a third aspect, an embodiment of the present disclosure also provides a base station, which may include a memory and a processor coupled to the memory, wherein

the memory may be configured to store executable instructions, and when the executable instructions are executed, to make the processor capable of:

generating, based on a cell ID of an LTE cell, a resource allocation random factor M for the LTE cell;

generating a resource allocation random number K using the resource allocation random factor M, the resource allocation random number K being greater than or equal to 0 and being less than or equal to N1−N2, the N1 being a total number of PRBs corresponding to a system bandwidth of an LTE system, and the N2 being a total number of PRBs needing to be scheduled to the LTE cell currently;

determining a start position for allocating PRBs to the LTE cell according to the resource allocation random number K; and

allocating PRBs to the LTE cell from the start position.

According to a fourth aspect, an embodiment of the present disclosure also provides a computer readable storage medium having stored therein computer executable instructions for executing the method for resource allocation to an LTE cell.

The embodiments of the present disclosure have the beneficial effects as follows:

according to the resource allocation method and apparatus for an LTE cell, the base station and the storage medium provided by the embodiments of the present disclosure, a resource allocation random factor M is generated for the LTE cell based on the cell ID of the LTE cell to which a resource is to be allocated; then, the resource allocation random number K is generated using the resource allocation random factor M, the generated resource allocation random number K being greater than or equal to 0 and being less than or equal to N1−N2, the N1 being the total number N1 of PRBs corresponding to the system bandwidth of the LTE system, and the N2 being the total number of PRBs needing to be scheduled to the LTE cell currently; the start position for allocating PRBs to the LTE cell is determined according to the resource allocation random number K; and the PRBs are allocated to the LTE cell from the start position. It can be seen that according to the technical solutions provided by the embodiments of the present disclosure, a PRB resource is allocated to each LTE cell randomly. Thus, the probability of overlapping of the PRBs between all LTE cells can be greatly reduced, the probability of mutual interference between adjacent cells can be reduced, and the performance of an entire network is improved, thereby further increasing the satisfaction of user experience.

### BRIEF DESCRIPTION OF THE DRAWINGS

FIG. 1 is a conventional diagram of allocation of PRBs between LTE cells;

FIG. 2 is a flow diagram of a method for allocating a resource to an LTE cell according to embodiment 1 of the present disclosure;

FIG. 3 is a flow diagram of generation of a random number K of resource allocation according to embodiment 1 of the present disclosure;

FIG. 4 is a flow diagram of a method for allocating a resource to an uplink physical channel of an LTE cell according to embodiment 1 of the present disclosure;

FIG. 5 is a flow diagram of a method for allocating a resource to a downlink physical channel of an LTE cell according to embodiment 1 of the present disclosure;

FIG. 6-1 is a structure diagram 1 of a apparatus for allocating a resource to an LTE cell according to embodiment 2 of the present disclosure;

FIG. 6-2 is a composition structure diagram of a random number acquisition module in an apparatus for resource allocation to an LTE cell according to embodiment 2 of the present disclosure;

FIG. 7 is a structure diagram 2 of an apparatus for resource allocation to an LTE cell according to embodiment 2 of the present disclosure;

FIG. 8 is a structure diagram of a base station according to embodiment 3 of the present disclosure; and

FIG. 9 is a diagram of allocation of PRBs between LTE cells according to embodiment 3 of the present disclosure.

### DETAILED DESCRIPTION

In the embodiments of the present disclosure, PRB resources are allocated to each LTE cell randomly. Thus, the probability of overlapping of the PRBs among all LTE cells can be greatly reduced, the probability of mutual interference between adjacent cells can be reduced, and the performance of an entire network is improved, and the satisfaction of user experience is further increased. The technical solutions of the present disclosure are further described below with reference to specific embodiments and the drawings in detail.

### Embodiment 1

As shown in FIG. 2, a method for resource allocation to an LTE cell provided by the embodiment includes the steps as follows.

Step 101: Based on a cell ID of an LTE cell to which PRBs are to be allocated, a random factor M of resource allocation is generated for the LTE cell.

Step 102: A random number K of the resource allocation is generated using the random factor M of the resource allocation.

Here, the random number K of the resource allocation is greater than or equal to 0 and is less than or equal to N1−N2, N1 being a total number of PRBs corresponding to a system bandwidth of an LTE system, and N2 being a total number of PRBs needing to be scheduled to the LTE cell currently.

Step 103: A start position for allocating PRBs to the LTE cell is determined according to the random number K of the resource allocation.

Step 104: PRBs are allocated to the LTE cell starting from the determined start position.

In the embodiment, Step 101 or Step 102 may further include the step of acquiring the total number N1 of PRBs corresponding to the system bandwidth of the LTE system and/or acquiring the total number N2 of PRBs currently needing to be scheduled to the LTE cell.

In Step 101, when the resource allocation random factor M is generated for the LTE cell based on the cell ID of the LTE cell, any parameters relevant to a wireless system can be adopted theoretically as long as it can be guaranteed that resource allocation random factors M generated for all cells are different as far as possible. The example descriptions are executed below in following multiple manners, but it shall be understood that available manners may include, but not limited to, the following multiple manners.

The first manner refers to directly taking the cell ID of the LTE cell as the resource allocation random factor M of the LTE cell.

The second manner refers to taking the sum of the cell ID of the LTE cell and a system frame number sysFn of the LTE system at a current TTI as the resource allocation random factor M of the LTE cell.

The third manner refers to taking the sum of the cell ID of the LTE cell and a system subframe number subSysFn of the LTE system at the current TTI as the resource allocation random factor M of the LTE cell.

The fourth manner refers to taking the sum of the cell ID of the LTE cell and the system frame number sysFn and system subframe number subSysFn of the LTE system at the current TTI as the resource allocation random factor M of the LTE cell.

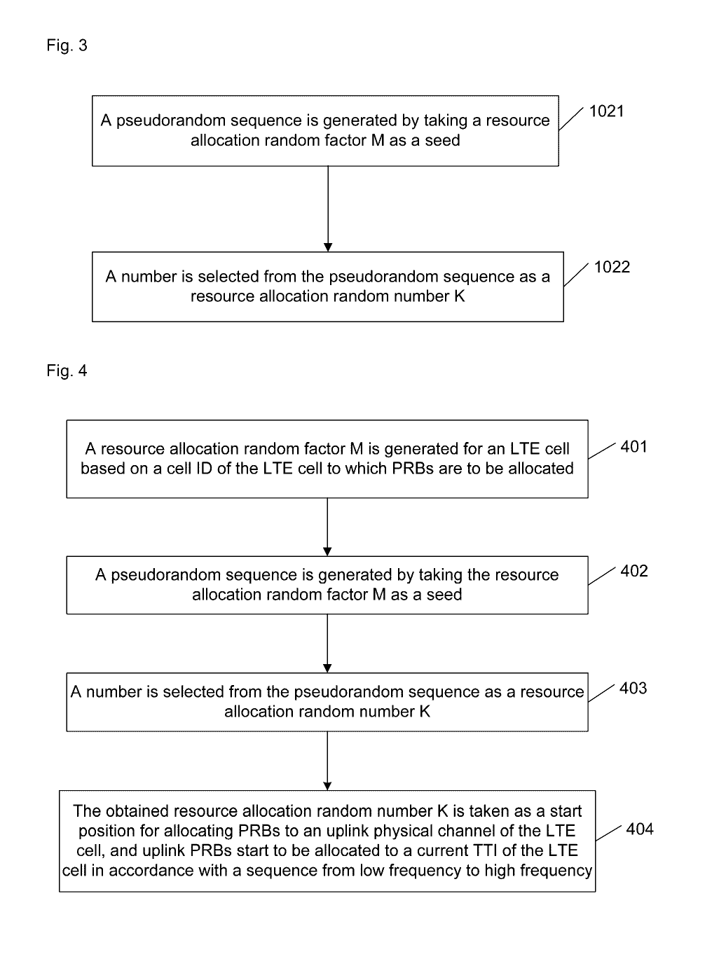

As shown in FIG. 3, the step 102 includes the steps as follows.

Step 1021: A pseudorandom sequence is generated by taking the resource allocation random factor M as a seed.

Here, the step 1021 refers to initializing a pre-set random sequence using the resource allocation random factor M.

Step 1022: A number is selected from the pseudorandom sequence as the resource allocation random number K.

Here, the resource allocation random number K is greater than or equal to 0 and is less than or equal to N1−N2.

In the embodiment, allocation of a resource to the LTE cell includes allocation of PRBs to an uplink physical channel (UL PDSCH) and a downlink physical channel (DL PDSCH) of the LTE cell. The allocation processes for the uplink physical channel and the downlink physical channel are described below respectively.

When PRBs are allocated to the uplink physical channel of the LTE cell, the total number N1 of acquired PRBs is a total number of PRBs corresponding to an uplink system bandwidth of the LTE system, and the total number N2 of acquired PRBs is a total number of PRBs needing to be scheduled to the LTE cell currently, for example, within the current TTI. As shown in FIG. 4, the process of allocating the PRBs to the uplink physical channel of the LTE cell includes the steps as follows.

Step 401: Based on a cell ID of an LTE cell to which PRBs are to be allocated, a resource allocation random factor M is generated for the LTE cell.

Here, M=cell ID+sysFn+subSysFn.

Step 402: A pseudorandom sequence is generated by taking the resource allocation random factor M as a seed.

Here, the step 402 refers to initializing a pre-set random sequence using the resource allocation random factor M.

Step 403: A number is selected from the pseudorandom sequence as a resource allocation random number K.

Here, K=Rand[M,(0,N1−N2)],

where Rand[ ] is a random-number generation function; and Rand[M,(0,N1−N2)] is generating a random number between 0 and N1−N2, and a random sequence from which the random number is generated takes the resource allocation random factor M as a seed.

Step 404: The obtained resource allocation random number K is taken as a start position for allocating the PRBs to the uplink physical channel of the LTE cell, and uplink PRBs start to be allocated to the LTE cell at the current TTI in accordance with a sequence from low frequency to high frequency.

In the embodiment, the PRBs can be allocated to the uplink physical channels of all LTE cells of the LTE system in accordance with the above manners, and within each TTI, the start positions for allocating the PRBs to the uplink physical channels of all LTE cells are randomly staggered, so that inter-cell interference can be reduced.

When the PRBs are allocated to the downlink physical channel of the LTE cell, the total number N1 of acquired PRBs is a total number of PRBs corresponding to a downlink system bandwidth of the LTE system, and the total number N2 of acquired PRBs is a total number of PRBs needing to be scheduled to the LTE cell currently, for example, within the current TTI.

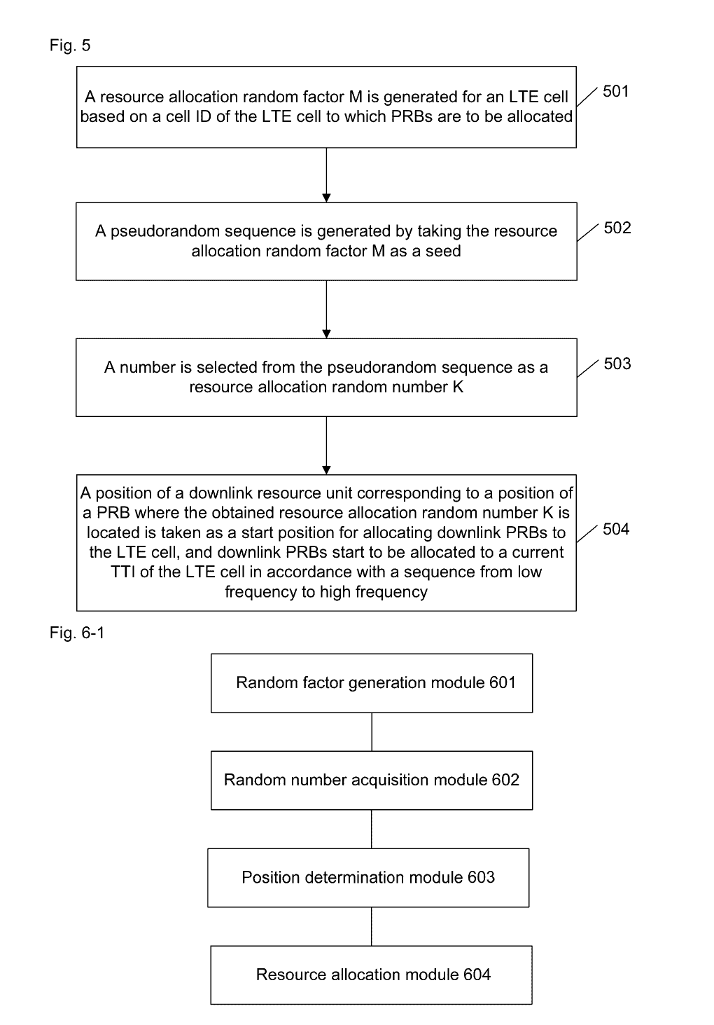

At this time, the method also includes that: a size H of a downlink resource unit corresponding to the downlink system bandwidth of the LTE system is acquired. As shown in FIG. 5, the process of allocating the PRBs to the downlink physical channel of the LTE cell includes the steps as follows.

Step 501: Based on a cell ID of an LTE cell to which PRBs are to be allocated, a resource allocation random factor M is generated for the LTE cell.

Here, M=cell ID+sysFn+subSysFn.

Step 502: A pseudorandom sequence is generated by taking the resource allocation random factor M as a seed.

Here, Step 502 refers to initializing a pre-set random sequence using the resource allocation random factor M.

Step 503: A number is selected from the pseudorandom sequence as a resource allocation random number K.

Here, K=H*floor[Rand(M,(0,N1−N2))/H], where

floor[ ] represents rounding down; Rand( ) is a random-number generation function; Rand(M,(0,N1−N2)) is generating a random number between 0 and N1−N2, and a random sequence from which the random number is generated takes the resource allocation random factor M as a seed; and H is the size of the downlink resource unit corresponding to the downlink system bandwidth of the LTE system.

Step 504: A position of the downlink resource unit corresponding to a position of a PRB where the obtained resource allocation random number K is located is taken as a start position for allocating downlink PRBs to the LTE cell, and downlink PRBs start to be allocated to the LTE cell at the current TTI in accordance with a sequence from low frequency to high frequency.

In the embodiment, the PRBs can be allocated to the downlink physical channels of all LTE cells of the LTE system in accordance with the above manners, and within each TTI, the start positions for allocating the PRBs to the downlink physical channels of all LTE cells are randomly staggered, so that inter-cell interference can be reduced.

In the embodiment, the above manners are applicable to allocation of the PRBs to the downlink physical channel of the LTE cell based on various allocation manners such as a Localized Virtual Resource Blocks (LVRB) allocation manner, a Type0/Type1 allocation manner, and the like. However, when the PRBs are allocated to the downlink physical channel of the LTE cell according to a rule of continuous allocation of PRBs (for example, the LVRB allocation manner is adopted according to the rule), the process of allocating the PRBs to the LTE cell from the determined start position in the embodiment further includes that:

when it is determined that N1−K−J<N2, an available PRB segment is searched for in a direction from low frequency to high frequency starting from a position of a lowest-frequency PRB, and a start position of the downlink resource unit corresponding to a start position of the PRB segment is taken as a new start position for allocating the PRBs to the downlink physical channel of the cell, wherein J is a total number of occupied PRBs.

### Embodiment 2

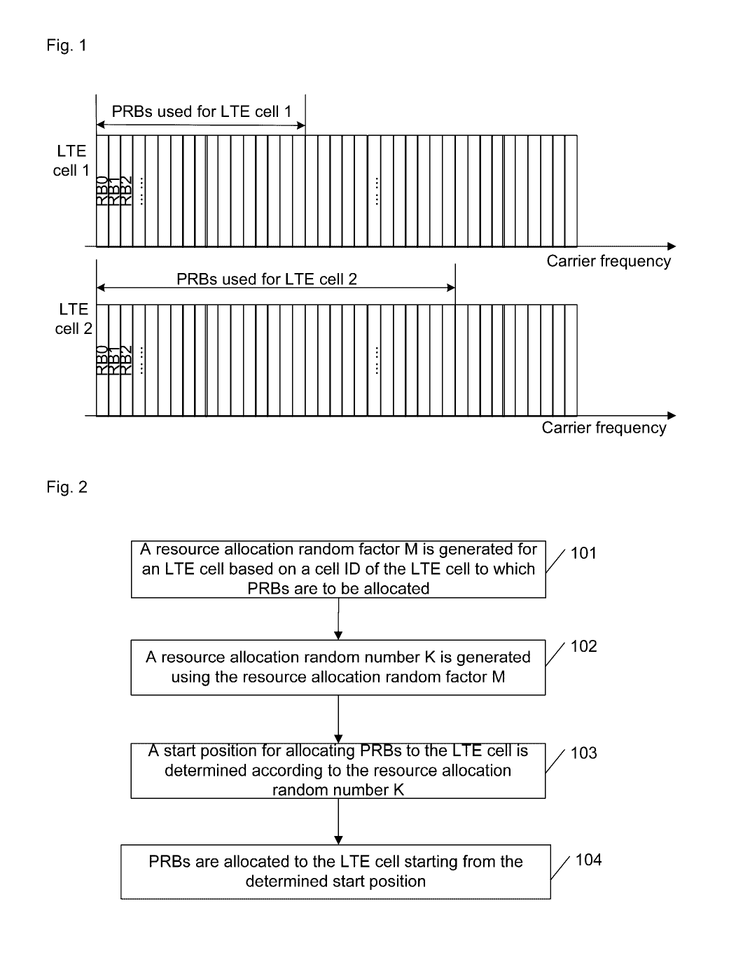

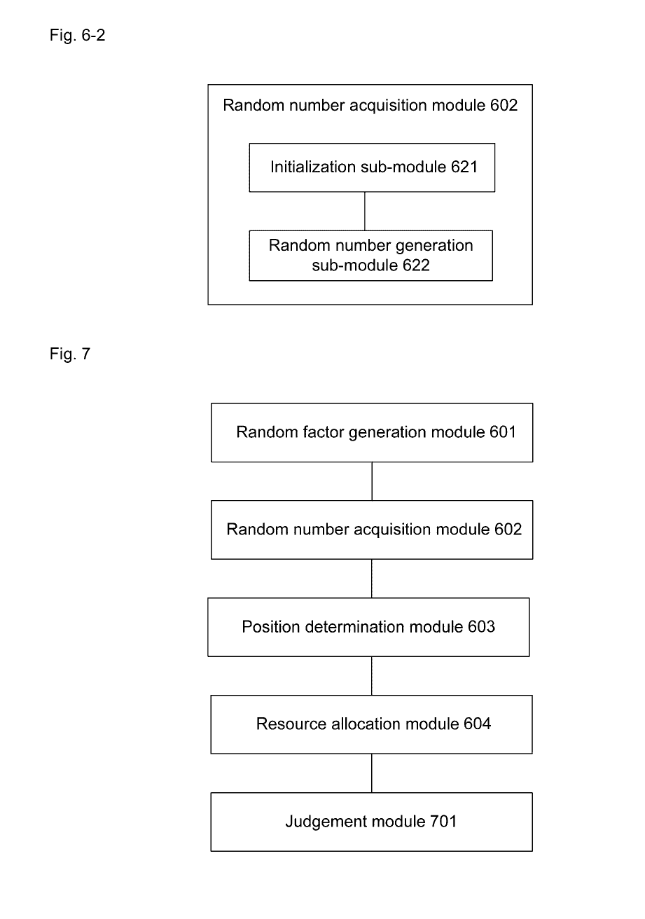

As shown in FIG. 6-1, a apparatus for resource allocation to an LTE cell provided by the embodiment includes a random factor generation module 601, a random number acquisition module 602, a position determination module 603 and a resource allocation module 604, wherein

the random factor generation module 601 is configured to generate, based on a cell ID of an LTE cell to which a resource is to be allocated, a resource allocation random factor M for the LTE cell;

the random number acquisition module 602 is configured to generate a resource allocation random number K using the resource allocation random factor M, the resource allocation random number K being greater than or equal to 0 and being less than or equal to N1−N2, N1 being a total number N1 of PRBs corresponding to a system bandwidth of an LTE system, and N2 being a total number of PRBs needing to be scheduled to the LTE cell currently;

the position determination module 603 is configured to determine a start position for allocating PRBs to the LTE cell according to the resource allocation random number K; and

the resource allocation module 604 is configured to allocate PRBs to the LTE cell from the start position.

When the random factor generation module generates the resource allocation random factor M for the LTE cell based on the cell ID of the LTE cell, any parameters relevant to a wireless system can be adopted theoretically as long as it can be guaranteed that resource allocation random factors M generated for all cells are different as far as possible. The example descriptions are illustrated below in following multiple manners, but it shall be understood that available manners may include, but not limited to, the following multiple manners.

The first manner refers to directly taking the cell ID of the LTE cell as the resource allocation random factor M of the LTE cell.

The second manner refers to taking the sum of the cell ID of the LTE cell and a system frame number sysFn of the LTE system at a current TTI as the resource allocation random factor M of the LTE cell.

The third manner refers to taking the sum of the cell ID of the LTE cell and a system subframe number subSysFn of the LTE system at the current TTI as the resource allocation random factor M of the LTE cell.

The fourth manner refers to taking the sum of the cell ID of the LTE cell and the system frame number sysFn and system subframe number subSysFn of the LTE system at the current TTI as the resource allocation random factor M of the LTE cell.

As shown in FIG. 6-2, the random number acquisition module 602 may further include an initialization sub-module 621 and a random number generation sub-module 622, wherein

the initialization sub-module 621 is configured to initialize a pre-set random sequence using the resource allocation random factor M, and generate a pseudorandom sequence by taking the resource allocation random factor M as a seed; and

the random number generation sub-module 622 is configured to select a number from the pseudorandom sequence as the resource allocation random number K.

In the embodiment, when PRBs are allocated to an uplink physical channel of the LTE cell, the total number N1 of PRBs is a total number of PRBs corresponding to an uplink system bandwidth of the LTE system, and the total number N2 of PRBs is a total number of uplink PRBs needing to be scheduled to the LTE cell currently; the position determination module determines the resource allocation random number K as a start position for allocating the PRBs to the uplink physical channel of the LTE cell;

correspondingly, the random number generation sub-module 622 is configured to select a number from the pseudorandom sequence as the resource allocation random number K, K=Rand[M,(0,N1−N2)];

Rand[ ] is a random-number generation function; and Rand[M,(0,N1−N2)] is a generating random number between 0 and N1−N2, and a random sequence from which the random number is generated takes the resource allocation random factor M as a seed.

In the embodiment, when PRBs are allocated to a downlink physical channel of the LTE cell, the total number N1 of PRBs is a total number of PRBs corresponding to a downlink system bandwidth of the LTE system, and the total number N2 of PRBs is a total number of downlink PRBs needing to be scheduled to the LTE cell currently. The position determination module 603 is configured to determine a position of a downlink resource unit corresponding to a position of a PRB where the resource allocation random number K is located as a start position for allocating downlink PRBs to the LTE cell.

Correspondingly, the random number generation sub-module 622 is configured to select a number from the pseudorandom sequence as the resource allocation random number K, K=H*floor[Rand(M,(0,N1−N2))/H];

floor[ ] represents rounding down; Rand( ) is a random-number generation function; Rand(M,(0,N1−N2)) is generating a random number between 0 and N1−N2, and the resource allocation random factor M is taken as a seed for generating a random sequence from which the random number is generated; and H is a size of the downlink resource unit corresponding to the downlink system bandwidth of the LTE system.

In the embodiment, the above manners are applicable to allocation of the PRBs to the downlink physical channel of the LTE cell based on various allocation manners such as an LVRB allocation manner, a Type0/Type1 allocation manner, and the like.

However, when the PRBs are allocated to the downlink physical channel of the LTE cell by following a PRB continuous allocation rule (for example, the LVRB allocation manner is adopted according to the rule). As shown in FIG. 7, the resource allocation apparatus in the embodiment further includes a judgement module 701, wherein

the judgement module 701 is configured to determine that N1−K−J<N2 in the process that the resource allocation module allocates the PRBs to the LTE cell from the start position, and search for an available PRB segment in a direction from low frequency to high frequency starting from a position of a lowest-frequency PRB; and

correspondingly, the position determination module 603 is further configured to take a start position of the downlink resource unit corresponding to a start position of the PRB segment as a new start position for allocating the PRBs to the downlink physical channel of the cell, J being a total number of occupied PRBs.

### Embodiment 3

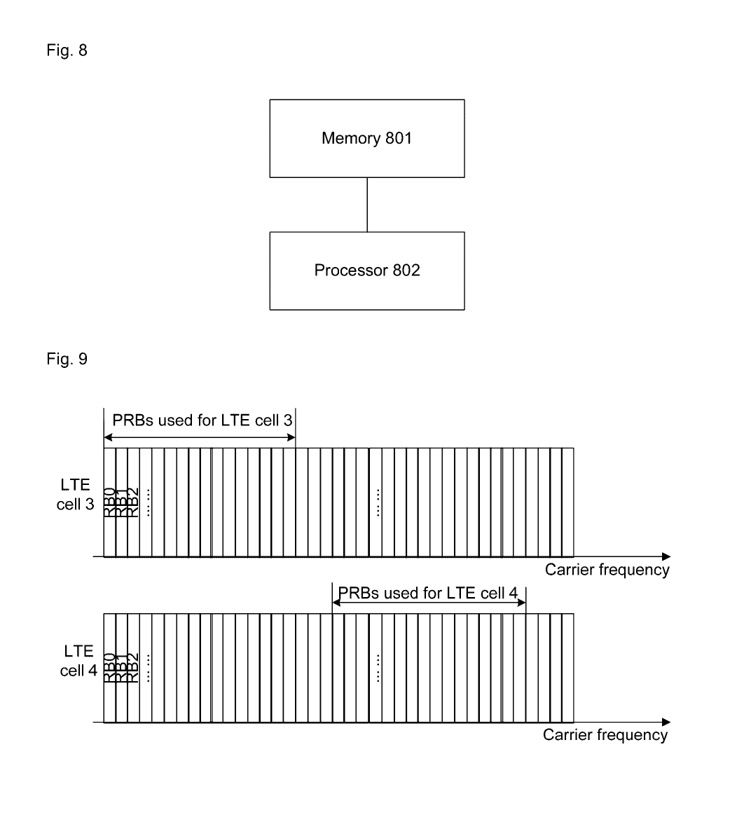

As shown in FIG. 8, a base station provided by the embodiment includes a memory 801 and a processor 802 coupled to the memory 801, wherein

the memory 801 is configured to store executable instructions, when the executable instructions are executed, to make the processor capable of:

generating, based on a cell ID of an LTE cell to which a resource is to be allocated, a resource allocation random factor M for the LTE cell;

generating a resource allocation random number K using the resource allocation random factor M, the resource allocation random number K being greater than or equal to 0 and being less than or equal to N1−N2, N1 being a total number N1 of PRBs corresponding to a system bandwidth of an LTE system, and N2 being a total number of PRBs needing to be scheduled to the LTE cell currently;

determining a start position for allocating PRBs to the LTE cell according to the resource allocation random number K; and

allocating PRBs to the LTE cell from the start position.

The processor 802 executes the executable instructions so as to randomly allocate a PRB resource to each LTE cell, so that the probability of overlapping of PRBs among all LTE cells can be greatly reduced. FIG. 9 shows a diagram of PRBs allocated to an LTE cell 3 and an LTE cell 4 through the above step. It can be seen from FIG. 9 that overlapped PRBs do not exist between the LTE cell 3 and the LTE cell 4. Thus, the probability of mutual interference between the two cells can be reduced, and the performance of an entire network is improved, thereby further increasing the satisfaction of user experience.

In the above step, when the resource allocation random factor M is generated for the LTE cell based on the cell ID of the LTE cell, any parameters relevant to a wireless system can be adopted theoretically as long as it can be guaranteed that resource allocation random factors M generated for all cells are different as far as possible. The example descriptions are executed below in following multiple manners, but it shall be understood that available manners may include, but not limited to, the following multiple manners.

The first manner refers to directly taking the cell ID of the LTE cell as the resource allocation random factor M of the LTE cell.

The second manner refers to taking the sum of the cell ID of the LTE cell and a system frame number sysFn of the LTE system at a current TTI as the resource allocation random factor M of the LTE cell.

The third manner refers to taking the sum of the cell ID of the LTE cell and a system subframe number subSysFn of the LTE system at the current TTI as the resource allocation random factor M of the LTE cell.

The fourth manner refers to taking the sum of the cell ID of the LTE cell and the system frame number sysFn and system subframe number subSysFn of the LTE system at the current TTI as the resource allocation random factor M of the LTE cell.

In the above step, the process of generating the resource allocation random number K using the resource allocation random factor M includes:

initializing a pre-set random sequence using the resource allocation random factor M, and generating a pseudorandom sequence by taking the resource allocation random factor M as a seed; and

selecting a number from the pseudorandom sequence as the resource allocation random number K, the resource allocation random number K being greater than or equal to 0 and being less than or equal to N1−N2.

In the embodiment, allocation of resources to the LTE cell includes allocation of PRBs to an uplink physical channel (UL PDSCH) and a downlink physical channel (DL PDSCH) of the LTE cell. The allocation processes for the uplink physical channel and the downlink physical channel are described below respectively.

When the PRBs are allocated to the uplink physical channel of the LTE cell, the total number N1 of acquired PRBs is a total number of PRBs corresponding to an uplink system bandwidth of the LTE system, and the total number N2 of acquired PRBs is a total number of PRBs needing to be scheduled to the LTE cell currently, for example, within the current TTI. The process of allocating the PRBs to the uplink physical channel of the LTE cell includes:

generating a resource allocation random factor M for the LTE cell based on a cell ID of an LTE cell to which PRBs are to be allocated, wherein M=cell ID+sysFn+subSysFn in this step;

initializing a pre-set random sequence using the resource allocation random factor M, and generating a pseudorandom sequence by taking the resource allocation random factor M as a seed;

selecting a number from the pseudorandom sequence as a resource allocation random number K, wherein specifically,

K=Rand[M,(0,N1−N2)],

where Rand[ ] is a random-number generation function, Rand[M,(0,N1−N2)] is a generating a random number between 0 and N1−N2, and the resource allocation random factor M is taken as a seed for generating a random sequence from which the random number is generated; and

taking the obtained resource allocation random number K as a start position for allocating the PRBs to the uplink physical channel of the LTE cell, and starting to allocate uplink PRBs to the LTE cell at the current TTI in accordance with a sequence from low frequency to high frequency.

In the embodiment, the PRBs can be allocated to the uplink physical channels of all LTE cells of the LTE system in accordance with the above manners, and within each TTI, the start positions for allocating the PRBs to the uplink physical channels of all LTE cells are randomly staggered, so that inter-cell interference can be reduced.

When the PRBs are allocated to the downlink physical channel of the LTE cell, the total number N1 of acquired PRBs is a total number of PRBs corresponding to a downlink system bandwidth of the LTE system, and the total number N2 of acquired PRBs is a total number of PRBs needing to be scheduled to the LTE cell currently, for example, within the current TTI.

At this time, the process also includes acquiring a size H of a downlink resource unit corresponding to the downlink system bandwidth of the LTE system. At this time, the process of allocating the PRBs to the downlink physical channel of the LTE cell includes:

generating a resource allocation random factor M for the LTE cell based on a cell ID of the LTE cell to which PRBs are to be allocated, wherein in the step, M=cell ID+sysFn+subSysFn;

initializing a pre-set random sequence using the resource allocation random factor M, and generating a pseudorandom sequence by taking the resource allocation random factor M as a seed;

selecting a number from the pseudorandom sequence as a resource allocation random number K, wherein specifically,

K=H*floor[Rand(M,(0,N1−N2))/H], where

floor[ ] represents rounding down; Rand( ) is a random-number generation function; Rand(M,(0,N1−N2)) is generating a random number between 0 and N1−N2, and the resource allocation random factor M is taken as a seed for generating a random sequence from which the random number is generated, and H is the size of the downlink resource unit corresponding to the downlink system bandwidth of the LTE system; and

A position of the downlink resource unit corresponding to a position of a PRB where the obtained resource allocation random number K is located is taken as a start position for allocating downlink PRBs to the LTE cell, and downlink PRBs starts to be allocated to the LTE cell at the current TTI in accordance with a sequence from low frequency to high frequency.

In the embodiment, the PRBs can be allocated to the downlink physical channels of all LTE cells of the LTE system in accordance with the above manners, and within each TTI, the start positions for allocating the PRBs to the downlink physical channels of all LTE cells are randomly staggered, so that inter-cell interference can be reduced.

In the embodiment, the above manners are applicable to allocation of the PRBs to the downlink physical channel of the LTE cell based on various allocation manners such as an LVRB allocation manner, a Type0/Type1 allocation manner, and the like. However, when the PRBs are allocated to the downlink physical channel of the LTE cell by following a PRB continuous allocation rule (for example, the LVRB allocation manner is adopted according to the rule), the process of allocating the PRBs to the LTE cell from the determined start position in the embodiment further includes:

when it is determined that N1−K−J<N2, searching for an available PRB segment in a direction from low frequency to high frequency starting from a position of a lowest-frequency PRB, and taking a start position of the downlink resource unit corresponding to a start position of the PRB segment as a new start position for allocating the PRBs to the downlink physical channel of the cell, wherein J is a total number of occupied PRBs.

The random factor generation module, the random number acquisition module, the position determination module and the resource allocation module in the apparatus for resource allocation to an LTE cell provided by the embodiment of the present disclosure, as well as all sub-modules in the random number acquisition module, can be realized by the processor in the base station, or can be realized by a specific logical circuit. In a specific embodiment process, the processor may be a Central Processing Unit (CPU), a Micro Processing Unit (MPU), a Digital Signal Processor (DSP) or a Field-Programmable Gate Array (FPGA).

In the embodiments of the present disclosure, if the method for resource allocation to an LTE cell is realized by a software function module which is sold or used as an independent product, the product can also be stored in a computer readable storage medium. Based on this understanding, the technical solutions of the embodiments of the present disclosure can be substantially embodied in a form of a software product or the parts contributing to the conventional art can be embodied in a form of a software product, and the computer software product is stored in a storage medium, including a plurality of instructions enabling a computer device which may be a personal computer, a server or a network device to execute all or part of the method according to each embodiment of the present disclosure. The storage medium includes various media capable of storing program codes, such as a U disk, a mobile hard disk, a Read Only Memory (ROM), a disk or an optical disc. Thus, the embodiments of the present disclosure are not limited to combination of any specific hardware and software.

Correspondingly, an embodiment of the present disclosure also provides a computer readable storage medium. A computer executable instruction is stored in the computer readable storage medium and is configured to execute the method for resource allocation to an LTE cell provided by each embodiment of the present disclosure.

The above is further detailed descriptions for the present disclosure with reference to the specific embodiments, and it cannot be considered that specific implementations of the present disclosure are only limited to these descriptions. Those skilled in the technical field within which the present disclosure falls can also make simple deductions or replacements without departing from the concept of the present disclosure. These simple deductions or replacements shall be considered as falling within the protection scope of the present disclosure.

### INDUSTRIAL APPLICABILITY

In the embodiments of the present disclosure, a resource allocation random factor M is generated for an LTE cell based on the cell ID of the LTE cell; a resource allocation random number K is generated using the resource allocation random factor M, the resource allocation random number K being greater than or equal to 0 and being less than or equal to N1−N2, N1 being the total number of PRBs corresponding to the system bandwidth of the LTE system, and N2 being the total number of PRBs needing to be scheduled to the LTE cell currently; the start position for allocating the PRBs to the LTE cell is determined according to the resource allocation random number K; and the PRBs are allocated to the LTE cell from the start position. Thus, according to the embodiments of the present disclosure, a PRB resource is allocated to each LTE cell in a random manner, the probability of overlapping of the PRBs between all LTE cells can be greatly reduced, the probability of mutual interference of adjacent cells is reduced, and the performance of an entire network is improved.

What is claimed is:

1. A method for resource allocation to a Long Term Evolution (LTE) cell, comprising:
generating a resource allocation random factor M for the LTE cell based on a cell identification number (cell ID) of the LTE cell;
generating a resource allocation random number K using the resource allocation random factor M, the resource allocation random number K being greater than or equal to 0 and being less than or equal to N1−N2, where the N1being a total number of Physical Resource Blocks (PRBs) corresponding to a system bandwidth of an LTE system, and the N2 being a total number of PRBs needing to be scheduled to the LTE cell currently;
determining a start position for allocating PRBs to the LTE cell according to the resource allocation random number K; and
allocating PRBs to the LTE cell from the start position.

2. The method for resource allocation to an LTE cell according to claim 1, wherein generating the resource allocation random factor M for the LTE cell based on the cell ID of the LTE cell comprises:
directly taking the cell ID of the LTE cell as the resource allocation random factor M of the LTE cell; or
taking a sum of the cell ID of the LTE cell and a system frame number of the LTE system at a current Transmission Time Interval (TTI) as the resource allocation random factor M of the LTE cell; or
taking a sum of the cell ID of the LTE cell and a system subframe number of the LTE system at the current TTI as the resource allocation random factor M of the LTE cell; or
taking a sum of the cell ID of the LTE cell and the system frame number and system subframe number of the LTE system at the current TTI as the resource allocation random factor M of the LTE cell.

3. The method for resource allocation to an LTE cell according to claim 1, wherein generating the resource allocation random number K using the resource allocation random factor M comprises:
generating a pseudorandom sequence by taking the resource allocation random factor M as a seed; and
selecting a number from the pseudorandom sequence and taking the selected number as the resource allocation random number K.

4. The method for resource allocation to an LTE cell according to claim 3, wherein when PRBs are allocated to an uplink physical channel of the LTE cell, the resource allocation random number K is a start position for allocating the PRBs to the uplink physical channel of the LTE cell, the total number N1 of PRBs being a total number of PRBs corresponding to an uplink system bandwidth of the LTE system, and the total number N2 of PRBs being a total number of uplink PRBs needing to be scheduled to the LTE cell currently;
correspondingly, a number is selected from the pseudorandom sequence as the resource allocation random number K, K=Rand[M,(0,N1−N2)];
where the Rand[ ] is a random-number generation function; the Rand[M,(0,N1−N2)] is generating a random number between 0 and N1−N2, and the resource allocation random factor M is taken as a seed for generating a random sequence from which the random number is generated.

5. The method for resource allocation to an LTE cell according to claim 3, wherein when PRBs are allocated to a downlink physical channel of the LTE cell, a position of a downlink resource unit corresponding to a position of a PRB where the resource allocation random number K is located is taken as a start position for allocating downlink PRBs to the LTE cell, where the total number N1 of PRBs being a total number of PRBs corresponding to a downlink system bandwidth of the LTE system, and the total number N2 of PRBs being a total number of downlink PRBs needing to be scheduled to the LTE cell currently;
correspondingly, a number is selected from the pseudorandom sequence as the resource allocation random number K, K=H*floor[Rand(M,(0,N1−N2))/H];
where the floor[ ]represents rounding down; the Rand( ) is a random-number generation function; the Rand(M,(0,N1−N2)) is generating a random number between 0 and N1−N2, and the resource allocation random factor M is taken as a seed for generating a random sequence from which the random number is generated, and the H is a size of the downlink resource unit corresponding to the downlink system bandwidth of the LTE system.

6. The method for resource allocation to an LTE cell according to claim 5, wherein when the PRBs are allocated to the downlink physical channel of the LTE cell according to a PRB continuous allocation rule, allocating the PRBs to the LTE cell from the start position further comprises:
when it is determined that N1−K−J<N2, J being a total number of occupied PRBs, searching for an available PRB segment in a direction from low frequency to high frequency starting from a position of a lowest-frequency PRB, and taking a start position of the downlink resource unit corresponding to a start position of the PRB segment as a new start position for allocating the PRBs to the downlink physical channel of the cell.

7. An apparatus for resource allocation to a Long Term Evolution (LTE) cell, comprising: a random factor generation module, a random number acquisition module, a position determination module and a resource allocation module, wherein
the random factor generation module is configured to generate a resource allocation random factor M for the LTE cell based on a cell identification number (cell ID) of the LTE cell;
the random number acquisition module is configured to generate a resource allocation random number K using the resource allocation random factor M, the resource allocation random number K being greater than or equal to 0 and being less than or equal to N1−N2, where the N1 being a total number of Physical Resource Blocks (PRBs) corresponding to a system bandwidth of an LTE system, and the N2 being a total number of PRBs needing to be scheduled to the LTE cell currently;
the position determination module is configured to determine a start position for allocating PRBs to the LTE cell according to the resource allocation random number K; and
the resource allocation module is configured to allocate PRBs to the LTE cell from the start position.

8. The apparatus for resource allocation to an LTE cell according to claim 7, wherein the random factor generation module is configured to directly take the cell ID of the LTE cell as the resource allocation random factor M of the LTE cell; or
the random factor generation module is configured to take a sum of the cell ID of the LTE cell and a system frame number of the LTE system at a current Transmission Time Interval (TTI) as the resource allocation random factor M of the LTE cell; or
the random factor generation module is configured to take a sum of the cell ID of the LTE cell and a system subframe number of the LTE system at the current TTI as the obtained resource allocation random factor M of the LTE cell; or
the random factor generation module is configured to take a sum of the cell ID of the LTE cell and the system frame number and system subframe number of the LTE system at the current TTI as the resource allocation random factor M of the LTE cell.

9. The apparatus for resource allocation to an LTE cell according to claim 7, wherein the random number acquisition module comprises an initialization sub-module and a random number generation sub-module, where
the initialization sub-module is configured to generate a pseudorandom sequence by taking the resource allocation random factor M as a seed, and
the random number generation sub-module is configured to select a number from the pseudorandom sequence and take the selected number as the resource allocation random number K.

10. The apparatus for resource allocation to an LTE cell according to claim 9, wherein when PRBs are allocated to an uplink physical channel of the LTE cell, the position determination module is configured to determine the resource allocation random number K as a start position for allocating the PRBs to the uplink physical channel of the LTE cell, the total number N1 of PRBs being a total number of PRBs corresponding to an uplink system bandwidth of the LTE system, and the total number N2 of PRBs being a total number of uplink PRBs needing to be scheduled to the LTE cell currently;
correspondingly, the random number generation sub-module is configured to select a number from the pseudorandom sequence as the resource allocation random number K, K=Rand[M,(0,N1−N2)];
where the Rand[ ] is a random-number generation function, the Rand[M,(0,N1−N2)] is generating a random number between 0 and N1−N2, and the resource allocation random factor M is taken as a seed for generating a random sequence from which the random number is generated.

11. The apparatus for resource allocation to an LTE cell according to claim 9, wherein when PRBs are allocated to a downlink physical channel of the LTE cell, the position determination module is configured to determine a position of a downlink resource unit corresponding to a position of a PRB where the resource allocation random number K is located as a start position for allocating downlink PRBs to the LTE cell, where the total number N1 of PRBs being a total number of PRBs corresponding to a downlink system bandwidth of the LTE system, and the total number N2 of PRBs being a total number of downlink PRBs needing to be scheduled to the LTE cell currently;
correspondingly, the random number generation sub-module is configured to select a number from the pseudorandom sequence as the resource allocation random number K, K=H*floor[Rand(M,(0,N1−N2))/H];
where the floor[ ] represents rounding down; the Rand( ) is a random-number generation function; the Rand(M,(0,N1−N2)) is generating a random number between 0 and N1−N2, and the resource allocation random factor M is taken as a seed for generating a random sequence from which the random number is generated, and the H is a size of the downlink resource unit corresponding to the downlink system bandwidth of the LTE system.

12. The apparatus for resource allocation to an LTE cell according to claim 11, further comprising a judgement module, wherein
when the resource allocation module allocates the PRBs to the downlink physical channel of the LTE cell according to a PRB continuous allocation rule, the judgement module is configured to determine that N1−K−J<N2 in a process that the resource allocation module allocates the PRBs to the LTE cell from the start position, J being a total number of occupied PRBs, and search for an available PRB segment in a direction from low frequency to high frequency starting from a position of a lowest-frequency PRB; and
correspondingly, the position determination module is further configured to take a start position of the downlink resource unit corresponding to a start position of the PRB segment as a new start position for allocating the PRBs to the downlink physical channel of the cell.

13. A base station, comprising a memory and a processor coupled to the memory, wherein
the memory is configured to store executable instructions, when the executable instructions are executed, to make the processor capable of:
generating, based on a cell identification number (cell ID) of a Long Term Evolution (LTE) cell, a resource allocation random factor M for the LTE cell;
generating a resource allocation random number K using the resource allocation random factor M, the resource allocation random number K being greater than or equal to 0 and being less than or equal to N1−N2, where the N1 being a total number of Physical Resource Blocks (PRB) corresponding to a system bandwidth of an LTE system, and the N2 being a total number of PRBs needing to be scheduled to the LTE cell currently;
determining a start position for allocating PRBs to the LTE cell according to the resource allocation random number K; and
allocating PRBs to the LTE cell from the start position.

14. A computer readable storage medium having stored therein computer executable instructions for executing the method for resource allocation to an LTE cell according to claim 1.

15. The method for resource allocation to an LTE cell according to claim 2, wherein generating the resource allocation random number K using the resource allocation random factor M comprises:
generating a pseudorandom sequence by taking the resource allocation random factor M as a seed; and
selecting a number from the pseudorandom sequence and taking the selected number as the resource allocation random number K.

16. The apparatus for resource allocation to an LTE cell according to claim 8, wherein the random number acquisition module comprises an initialization sub-module and a random number generation sub-module, where
the initialization sub-module is configured to generate a pseudorandom sequence by taking the resource allocation random factor M as a seed, and
the random number generation sub-module is configured to select a number from the pseudorandom sequence and take the selected number as the resource allocation random number K.

17. A computer readable storage medium having stored therein computer executable instructions for executing the method for resource allocation to an LTE cell according to claim 2.

18. A computer readable storage medium having stored therein computer executable instructions for executing the method for resource allocation to an LTE cell according to claim 3.

19. A computer readable storage medium having stored therein computer executable instructions for executing the method for resource allocation to an LTE cell according to claim 4.

20. A computer readable storage medium having stored therein computer executable instructions for executing the method for resource allocation to an LTE cell according to claim 5.
